(19) United States
(12) Patent Application Publication
(10) Pub. No.: US 2026/0290020 A1
(43) Pub. Date: Sep. 24, 2026

(54) IMAGE FORMING SYSTEM

(71) Applicant: FUJIFILM Business Innovation Corp., Tokyo (JP)

(72) Inventor: Kosuke NISHIZAWA, Kanagawa (JP)

(73) Assignee: FUJIFILM Business Innovation Corp., Tokyo (JP)

(21) Appl. No.: 19/333,174

(22) Filed: Sep. 18, 2025

(30) Foreign Application Priority Data
Mar. 18, 2025 (JP) 2025-043404

(51) Int. Cl. G06V 20/52; G08B 21/22; G08B 21/24

(52) U.S. Cl. CPC G06V 20/52; G08B 21/22; G08B 21/24

(57) ABSTRACT

An image forming system includes a control unit that performs different control when a second target that has been moving in conjunction with motion of a first target within a predetermined region is no longer moving in conjunction with the first target and has become stationary, the different control being different from control performed otherwise.

### CROSS-REFERENCE TO RELATED APPLICATIONS

This application is based on and claims priority under 35 USC 119 from Japanese Patent Application No. 2025-043404 filed Mar. 18, 2025.

### BACKGROUND

### i. Technical Field

The present disclosure relates to an image forming system.

### ii. Related Art

Japanese Unexamined Patent Application Publication No. 2016-215520 discloses an image forming device including a left property detection unit that detects the presence or absence of a left property of a user that uses the image forming device, and a transmission unit that transmits left property information about a left property to a shop-side terminal communicably connected to the image forming device when the presence of any left property is detected.

Japanese Unexamined Patent Application Publication No. 7-220186 discloses a game machine left property prevention device including a container that stores baggage carried by a player, a baggage detection unit that detects whether or not baggage is stored in the container, and a control unit that performs control so as to issue a warning when movement of the player is detected with any baggage detected in the container.

### SUMMARY

Conventionally, there has been known a device that determines a location for detection of an object in advance, and that detects a left property in accordance with whether or not there is any object at the location, in order to prevent a user from leaving behind an article that the user has used while using the device, etc.

However, in a configuration in which an object that is present at a determined location is detected as in the related art, it is not possible to detect an article placed at other locations.

Aspects of non-limiting embodiments of the present disclosure relate to detecting an object such as a left property in a wide range compared to when detecting an object that is present at a determined location.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming system including a control unit that performs different control when a second target that has been moving in conjunction with motion of a first target within a predetermined region is no longer moving in conjunction with the first target and has become stationary, the different control being different from control performed otherwise.

### BRIEF DESCRIPTION OF THE DRAWINGS

Exemplary embodiments of the present disclosure will be described in detail based on the following figures, wherein:

FIG. 1 illustrates an example of the overall configuration of an image forming system according to the present exemplary embodiment;

FIG. 2 illustrates an example of the hardware configuration of an image forming device in FIG. 1;

FIG. 3 illustrates a specific example of a detectable region;

FIG. 4 illustrates a specific example of the detectable region;

FIG. 5 illustrates a specific example of a case where a person detection region and a left property region are formed in the detectable region;

FIG. 6 illustrates a specific example of the case where a person detection region and a left property region are formed in the detectable region;

FIG. 7 illustrates an example of the functional configuration of a central processing unit (CPU) of the image forming device in FIG. 2;

FIG. 8 is a flowchart illustrating an example of the flow of an object determination process, a left property determination process, and a left property notification process by the image forming device in FIG. 7 for a case where a left property region is not formed in the detectable region;

FIG. 9 is a flowchart illustrating an example of the flow of an object determination process, a left property determination process, and a left property notification process by the image forming device in FIG. 7 for a case where a left property region is formed in the detectable region; and

FIG. 10 illustrates a specific example of a case where a different person is present in a person detection region when a person has left the person detection region.

### DETAILED DESCRIPTION

An exemplary embodiment of the present disclosure will be described below with reference to the accompanying drawings.

### Configuration of Image Forming System

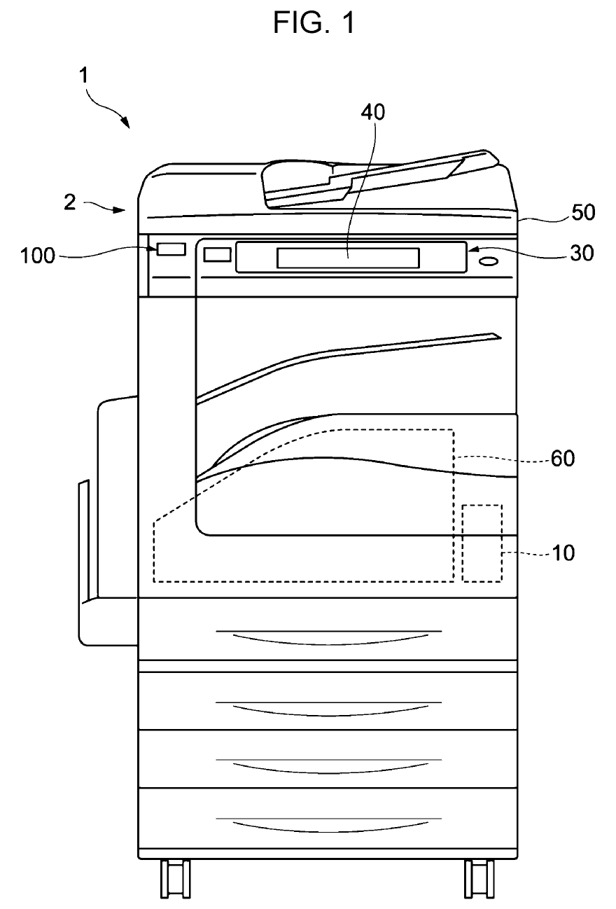

FIG. 1 illustrates an example of the overall configuration of an image forming system 1 according to the present exemplary embodiment.

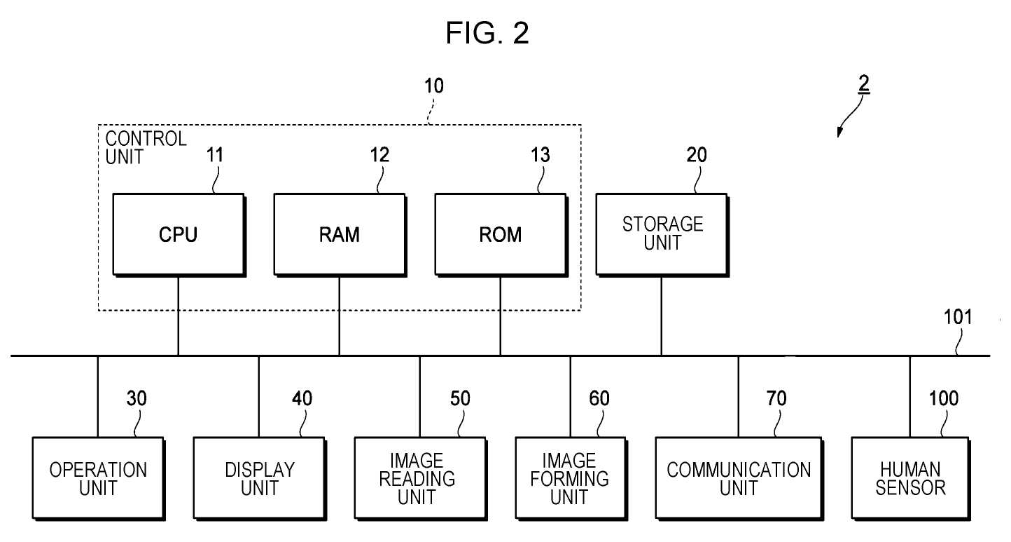

The image forming system 1 includes an image forming device 2 equipped with various functions such as printing, scanning, and copying. The image forming device 2 is intended to be installed at a location where people come and go, such as an office or a shared space. FIG. 1 illustrates a control unit 10, an operation unit 30, a display unit 40, an image reading unit 50, and an image forming unit 60 of the image forming device 2, and the configuration of these units will be described with reference to FIG. 2.

### Hardware Configuration of Image Forming Device

FIG. 2 illustrates an example of the hardware configuration of the image forming device 2 in FIG. 1.

As illustrated in FIG. 2 and FIG. 1 above, the image forming device 2 includes the control unit 10, the operation unit 30, the display unit 40, the image reading unit 50, and the image forming unit 60. As illustrated in FIG. 2, the image forming device 2 also includes a storage unit 20, a communication unit 70, and a human sensor 100. These functional units are connected to a bus 101 to exchange data via the bus 101.

The control unit 10 controls the above functional units of the image forming device 2. The control unit 10 includes a central processing unit (CPU) 11 as a computation unit, and a random access memory (RAM) 12 and a read only memory (ROM) 13 as storage units. The RAM 12 is a principal storage device (main memory), which is used as a work memory when the CPU 11 performs a computation process. The ROM 13 holds a program and data such as setting values prepared in advance, and the CPU 11 executes processing by reading the program and the data directly from the ROM 13. The program and the data are also stored in the storage unit 20. The CPU 11 reads the program stored in the storage unit 20 into the RAM 12 to execute the program.

In the present exemplary embodiment, various functions are implemented by the CPU 11 of the control unit 10 reading and executing programs. The functions implemented in the present exemplary embodiment include, besides controlling operation of the functional units, controlling a region (hereinafter occasionally referred to as a "detectable region") in which the human sensor 100 is able to detect the presence of a person. These functions will be discussed in detail later.

The storage unit 20 is a functional unit that, besides storing the program to be executed by the CPU 11 and the data as described above, stores a variety of data generated by various operation such as image data read by the image reading unit 50. The storage unit 20 is implemented by a storage device such as a magnetic disk device or a solid-state drive (SSD), for example.

The operation unit 30 is a functional unit that receives an operation by a user. The operation unit 30 includes a hardware key, a touch sensor that outputs a control signal according to a position pressed or touched with a finger or the like, etc., for example. The operation unit 30 may be constituted as a touch panel obtained by combining a touch sensor and a liquid crystal display that constitutes the display unit 40.

The display unit 40 is a functional unit that displays an information image that presents various information on the user, a preview image of an image to be subjected to processing such as reading and outputting, an operation image to be operated by the user, etc. The display unit 40 is constituted by a liquid crystal display, for example. The above operation unit 30 and the display unit 40 may be combined to be used as a user interface unit that allows the user to input and output information to and from the image forming device 2.

The image reading unit 50 is a functional unit that optically reads an image on a document. The method of reading an image is not specifically limited, and a charge coupled devices (CCD) method in which reflected light of light emitted from a light source to a document is reduced by a lens and received by CCDs may be used, for example. Alternatively, a contact image sensor (CIS) method in which reflected light of light sequentially emitted from a light emitting diode (LED) light source to a document is received by a CIS may be used, for example.

The image forming unit 60 is a functional unit that forms an image based on image data using an image forming material on a medium such as paper. Examples of the method of forming an image on a medium include an electrophotographic system in which a toner is used as the image forming material and a toner attached to a photoconductor is transferred to the medium to form an image.

The communication unit 70 is a functional unit that transmits and receives an instruction and data to and from an external device. As the communication unit 70, an interface that supports the method of communication with the external device is used. The connection with the external device may be through a network or through a direct connection. The communication line may be either wired or wireless.

The human sensor 100 is a sensor that detects a person that is present around the image forming device 2. The human sensor 100 may be a detection sensor that includes an output unit that outputs a signal and a detection unit that detects the signal, for example. In this case, the human sensor 100 obtains different detection results in accordance with whether the signal transmitted from the output unit is detected by the detection unit. The human sensor 100 may be various sensors that are capable of detecting the presence of a moving body such as a person.

The human sensor 100 may be an ultrasonic sensor, a sensor that uses light, a sensor that uses radio waves, a sensor that recognizes a human body temperature, etc., for example. It is also possible to recognize a person by analyzing an image captured by various capturing units. As an example of these sensors, there is an aspect in which the presence of a person is detected by an output unit transmitting a signal to a person and a detection unit detecting a signal reflected by the person. In this aspect, the presence of a person is not detected when a reflected signal is not detected.

For example, in an ultrasonic sensor, a person is detected by an output unit transmitting ultrasonic waves to a person and a detection unit detecting ultrasonic waves reflected by the person. In a sensor that uses light, a person is detected by an output unit emitting light to a person and a detection unit receiving light reflected by the person. In a sensor that uses radio waves, a person is detected by an output unit radiating radio waves to a person and a detection unit receiving radio waves reflected by the person.

The human sensor 100 according to the present exemplary embodiment has a function of adjusting the output intensity of the output unit. The human sensor 100 is able to change the detectable region of the human sensor 100 by adjusting the output intensity of the output unit, for example. Specifically, increasing the output intensity allows the signal to travel farther, thus increasing the detectable region. On the other hand, decreasing the output intensity reduces the reachable distance of the signal, thus reducing the detectable region.

### Detectable Region

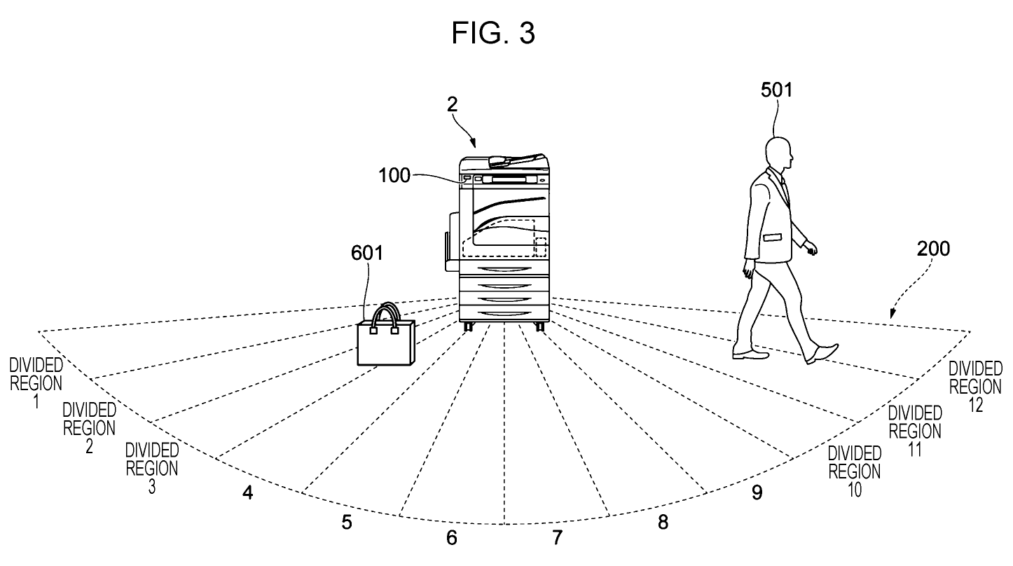

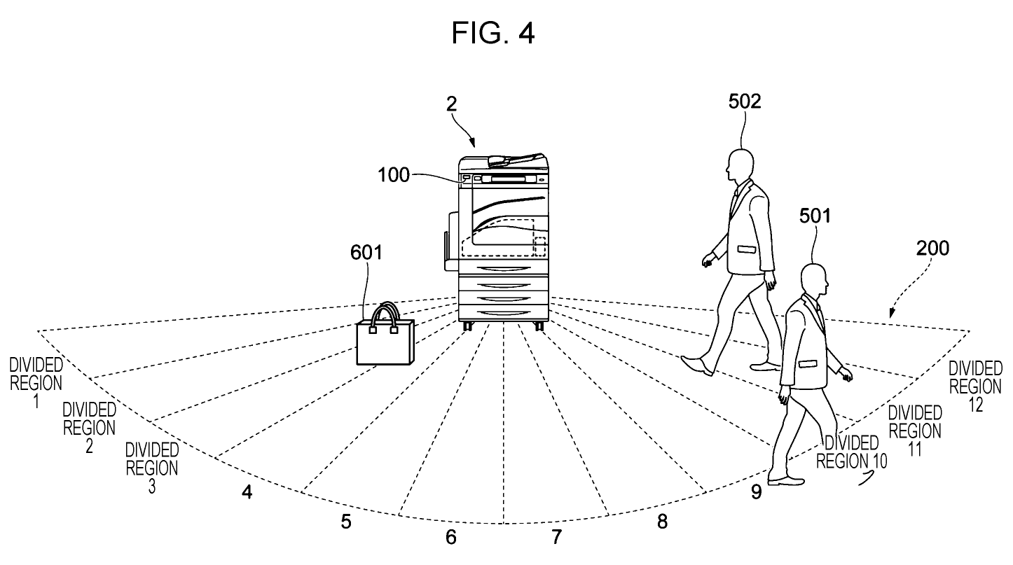

FIGS. 3 and 4 illustrate a specific example of a detectable region 200.

The human sensor 100 of the image forming device 2 outputs a signal such as ultrasonic waves, for example, in a specific direction at a predetermined output intensity to search for the presence of a person within a specific range. The human sensor 100 sequentially outputs this signal in a plurality of directions while varying the angle. This allows the human sensor 100 to search for the presence of a person in the detectable region 200 which may extend in an arcuate shape about the image forming device 2. For example, defining the range of approximately 0° to 180° extending in a sector shape about the image forming device 2 itself as the detectable region 200, the human sensor 100 is able to output a signal while varying the angle by approximately 10° each time.

The method for the image forming device 2 to control the direction of outputting a signal from the human sensor 100 may be a method in which the output unit itself of the human sensor 100 is rotated by a motor to vary the direction of outputting the signal, for example. Another example of the method may be a method in which the output unit of the human sensor 100 is fixed and a signal is reflected using a mirror member, the angle of which is adjustable by a motor, to control the output direction without rotating the output unit.

This makes it possible to form a detectable region 200 for the range of approximately 0° to 170° extending in a sector shape about the image forming device 2, as illustrated in FIG. 3, for example. The detectable region 200 illustrated in FIG. 3 is exemplary, and the present disclosure is not particularly limited thereto. The detectable region 200 is set in consideration of the environment in which the image forming device 2 is installed. It is also possible to expand and contract the detectable region 200 by controlling the output direction of a signal from the human sensor 100.

### Divided Region

The detectable region 200 is composed of a plurality of regions (hereinafter referred to as "divided regions") corresponding to each direction in which a signal is output from the human sensor 100. FIG. 3 illustrates divided regions 1 to 12, by way of example. The human sensor 100 sequentially outputs a signal to the divided regions 1 to 12 to detect the presence of a person in each of the regions. The signal output order is not limited to the above. For example, a signal may be sequentially output to the divided regions 12 to 1. The number of the divided regions is exemplary, and the present disclosure is not limited to the 12 divided regions illustrated in FIG. 3.

Of the detectable region, the range to be detected by the human sensor 100 may be set in advance. For example, it is conceivable that the human sensor 100 reacts unnecessarily when the image forming device 2 is installed at a corner such as near a wall of a room or at a location with much human traffic. In such a case, it is possible to suppress unnecessary detection by the human sensor 100 by setting the range to be detected by the human sensor 100 in advance, of the detectable region 200. For example, the range of the divided regions 7 to 12 illustrated in FIG. 3 may be set to be excluded from the detection target. In this case, it is possible to detect the presence of a person in the range of the divided regions 1 to 6 by controlling the direction in which the output unit of the human sensor 100 outputs a signal. The human sensor 100 detects the presence of a person within the detectable region 200 by repeatedly performing a process of sequentially outputting a signal for each of the divided regions.

The human sensor 100 according to the present exemplary embodiment may be provided with a plurality of independent output units. For example, output units corresponding to the regions may be provided to search for the presence of a person in the respective regions. In this case, when the divided regions 1 to 12 illustrated in FIG. 3 are described by way of example, 12 output units corresponding to the respective regions may be provided to output signals in different directions, in order to individually search in the regions. When such a configuration is adopted, it is possible to make a search in the regions concurrently, improving the detection accuracy. A smaller number of output units than the number of the divided regions may be provided to output signals while varying the angle of such signals.

### Object Determination Process

The image forming device 2 is able to determine an object that is moving alone, among objects detected as being present in each of the divided regions of the detectable region 200 as a predetermined region in the present disclosure, as a "person" as a first target in the present disclosure. In addition, the image forming device 2 is able to determine an object that is stationary when alone, among the objects detected as being present in each of the divided regions of the detectable region 200, as an "article" as a second target in the present disclosure. Hereinafter, the process by the image forming device 2 to determine a "person" and an "article" will be referred to as an "object determination process".

The image forming device 2 is able to detect that a plurality of objects is moving in conjunction with each other in the detectable region 200 and thereafter detect that the plurality of objects is no longer moving in conjunction with each other. Further, the image forming device 2 is able to detect whether the plurality of objects that are no longer moving in conjunction with each other include an object that keeps moving and an object that is stationary. When the plurality of objects that are no longer moving in conjunction with each other include an object that keeps moving and an object that is stationary, the image forming device 2 performs the object determination process as follows. That is, the image forming device 2 determines the object that keeps moving as a "person" and determines the object that is stationary as an "article".

In the example in FIG. 3, it is assumed that a person 501 carrying an article 601 (bag) has entered the detectable region 200 in order to use the image forming device 2. Then, the image forming device 2 detects that two objects are moving in conjunction with each other in the detectable region 200 and determines that the person 501 has entered the detectable region 200. After that, it is assumed that the person 501 has put the article 601 beside the image forming device 2 and has started to use the image forming device 2. Then, the image forming device 2 detects that the two objects are no longer moving in conjunction with each other, one of the objects is not stationary, and the other object is stationary. In this case, the image forming device 2 determines the one of the objects that is not stationary as the person 501 and determines the other object that is stationary as the article 601. Here, "stationary" means a state with no motion for a predetermined time or longer, for example.

When it is determined by the object determination process that the object that is present in the detectable region 200 includes a person 501 and an article 601, the image forming device 2 is able to perform control that is different from that performed otherwise. That is, the image forming device 2 is able to perform different control between when it is determined that the object that is present in the detectable region 200 includes a person 501 and an article 601 and when it is not determined that the object that is present in the detectable region 200 includes a person 501 and an article 601. Here, examples of the case where it is not determined that the object that is present in the detectable region 200 includes a person 501 and an article 601 include the following case. That is, such examples include a case where it is detected that the plurality of objects that have been moving in conjunction with each other in the detectable region 200 are no longer moving in conjunction with each other and are both not stationary, and a case where it is detected that the plurality of objects keep moving in conjunction with each other in the detectable region 200.

### Left Property Determination Process

The image forming device 2 according to the present exemplary embodiment is able to perform, as the "different control" discussed above, a process (hereinafter referred to as a "left property determination process") of determining whether an article 601 has been left behind beside the image forming device 2. The left property determination process is performed as follows, for example. That is, when an object determined as a person 501 has left the detectable region 200 and an object determined as an article 601 remains in the detectable region 200, the image forming device 2 determines that the article 601 is a "left property" of the person 501. In the example in FIG. 3, the article 601 is stationary at a position between the divided region 3 and the divided region 4, and the person 501 is moving in the divided region 11, and the article 601 is determined as a "left property" of the person 501 when the person 501 keeps moving to leave the detectable region 200.

### Left Property Notification Process

When it is determined that the article 601 is a "left property" of the person 501 by performing the left property determination process, the image forming device 2 is able to perform, as the "different control", a process (hereinafter referred to as a "left property notification process") of notifying the person 501 that there is a left property. The method of notifying the person 501 that there is a left property is not particularly limited. For example, the image forming device 2 may make a notification by outputting a sound, or the image forming device 2 may make a notification by transmitting a mail if a mail address of the person 501 has been registered in advance. If the notification method uses a sound, it is possible to immediately make a notification that there is a left property, but there is a concern for a secondary complaint about noise or the like. On the other hand, if the notification method uses mail transmission, there is no concern that could lead to a secondary complaint, but there is a high risk of theft since it is not possible to immediately make a notification that there is a left property.

Therefore, the notification method may be selected and applied in accordance with the mode of use and the situation of use of the image forming device 2. For example, in a situation in which a person 502 other than the person 501 has entered the detectable region 200, as in the situation illustrated in FIG. 4, the image forming device 2 may make a sound notification since there is a risk of theft. On the other hand, in a situation in which no person 502 other than the person 501 has entered the detectable region 200, a notification may be made by mail transmission since there is a low risk of theft.

The image forming device 2 may not perform a left property notification process when a predetermined condition (hereinafter referred to as a "non-notification condition") is met, even if it is determined by the object determination process that an article 601 is present in the detectable region 200 and a person 501 has ceased to be present in the detectable region 200. Examples of the non-notification condition include a condition that determines an event in which a person 501 that has left the detectable region 200 immediately comes back to the detectable region 200, and a condition that determines the occurrence of an error in the image forming device 2.

### Person Detection Region and Left Property Region

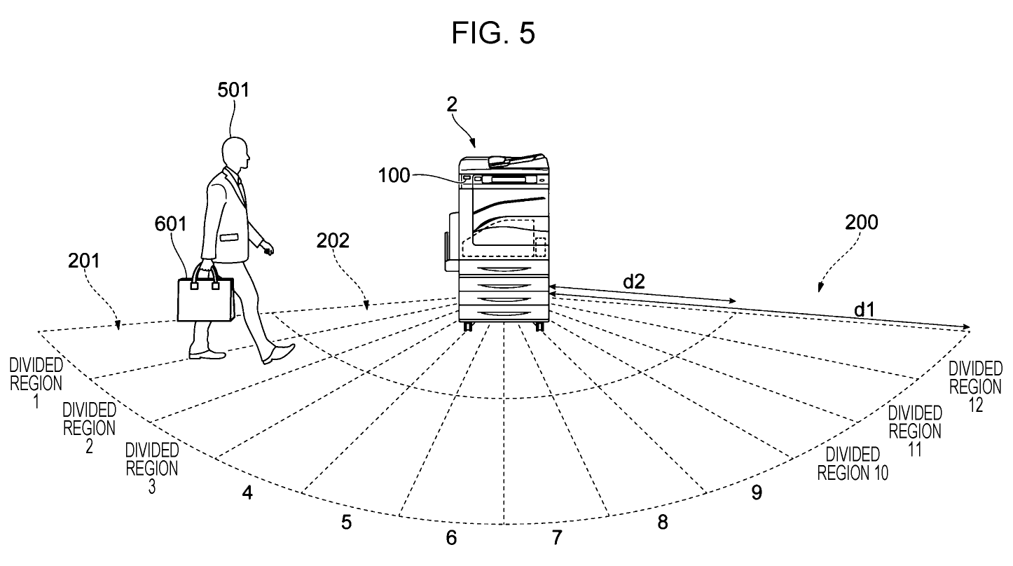

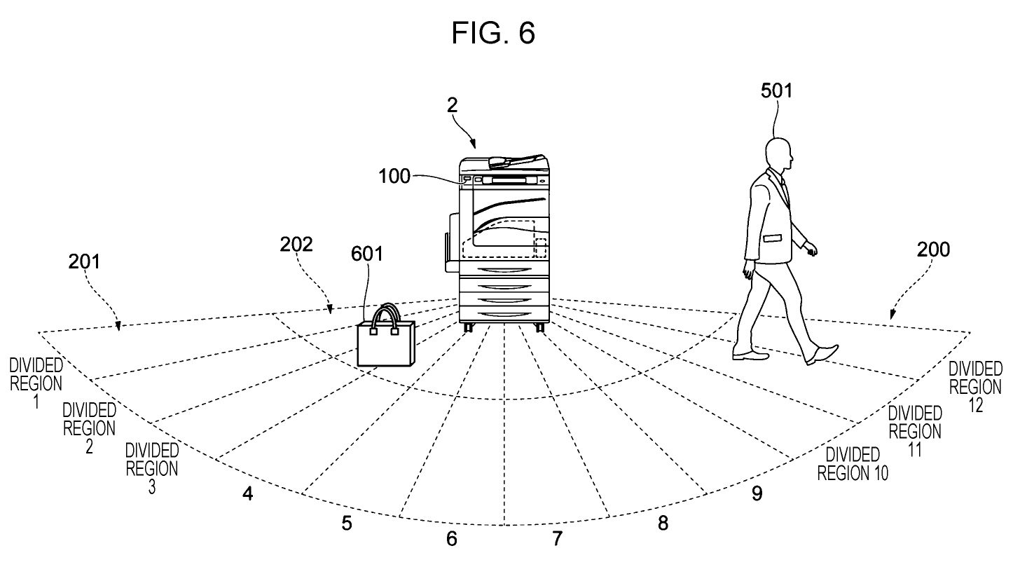

FIGS. 5 and 6 illustrate a specific example of a case where a person detection region and a left property region are formed in the detectable region 200.

The image forming device 2 is able to form a plurality of regions corresponding to the distance from the image forming device 2 in the detectable region 200. The regions corresponding to the distance from the image forming device 2 are formed in accordance with thresholds of the distance from the image forming device 2 when such thresholds are set. In FIG. 5, a distance d1 and a distance d2 which is shorter than the distance d1 are set as the thresholds of the distance from the image forming device 2. The distance d2 may be set for each of the divided regions.

The distance d1 is a distance set in advance as a threshold that defines the detectable region 200. When the distance d1 is set, the detectable region 200 is formed. The distance d2 is a distance set in advance as a threshold that defines a person detection region 201 and a left property region 202 in the detectable region 200. When the distance d2 is set, a person detection region 201 and a left property region 202 in a sector shape are formed in the detectable region 200. If the distance d2 set for each of the divided regions is not uniform, the left property region 202 may not be in a sector shape.

The image forming device 2 is able to perform the object determination process and the left property determination process to be described below, for example, when a person detection region 201 and a left property region 202 are formed in the detectable region 200. That is, when the image forming device 2 determines that a person 501 has entered the person detection region 201 as the object determination process, the image forming device 2 stores the state of the left property region 202 at the time when the person 501 has entered the person detection region 201 as the left property determination process.

The state of the left property region 202 to be stored in the image forming device 2 includes whether any person is present in the left property region 202 and whether any article is present in the left property region 202, for example. The state of the left property region 202 to be stored in the image forming device 2 also includes the number of persons, if any, that are present in the left property region 202 and the number of articles, if any, that are present in the left property region 202, for example. Such information is determined and stored for each of the divided regions.

In the example in FIG. 5, the state of the left property region 202 at the time when a person 501 carrying an article 601 (bag) has entered the person detection region 201 is a state in which no person or article is present. Therefore, the image forming device 2 stores the state of the left property region 202 as a state in which no person or article is present. After that, when the person 501 finishes using the image forming device 2 and leaves the detectable region 200, the image forming device 2 stores the state of the left property region 202 at that time.

FIG. 6 illustrates a state before the person 501 leaves the person detection region 201. When the person 501 leaves the person detection region 201, the left property region 202 is in a state in which only the article 601 is present. Therefore, the image forming device 2 stores a state in which only the article 601 is present in the left property region 202.

The image forming device 2 makes a comparison between the state of the left property region 202 stored when the person 501 has entered the person detection region 201 and the state of the left property region 202 stored when the person 501 has left the person detection region 201, and extracts a difference.

In the left property region 202 at the time when the person 501 has left the person detection region 201, an article 601 is present that was not present when the person 501 entered the person detection region 201. That is, the person 501 enters the person detection region 201 and the left property region 202 in this order and thereafter places the article 601 in the left property region 202 before the person 501 leaves the person detection region 201, and this state is continued. Therefore, the image processing device 2 performs the left property notification process.

### Functional Configuration of Image Forming Device

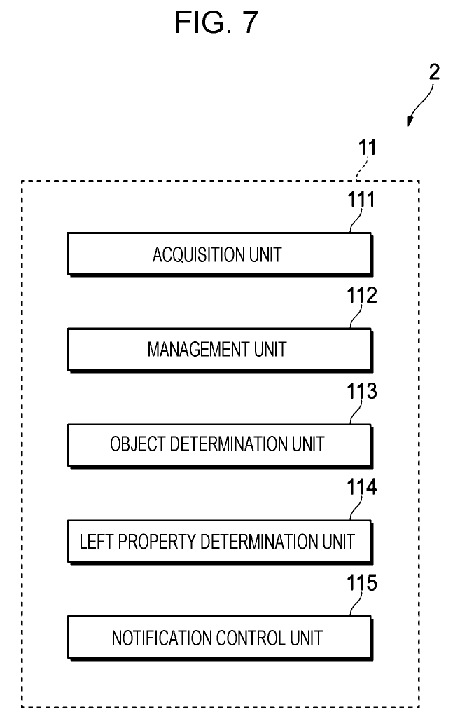

FIG. 7 illustrates an example of the functional configuration of the CPU 11 of the image forming device 2 in FIG. 2.

As illustrated in FIG. 7, in the CPU 11 of the image forming device 2, an acquisition unit 111, a management unit 112, an object determination unit 113, a left property determination unit 114, and a notification control unit 115 function in order to implement the object determination process, left property determination process, and left property notification process discussed above. These functions will be described below with reference to FIGS. 1 to 7.

The acquisition unit 111 acquires detection results from the human sensor 100 in FIG. 2. The acquisition unit 111 is able to acquire detection results for each of the divided regions of the detectable region 200. Examples of the detection results include an object being present, a plurality of objects moving in conjunction with each other, a plurality of objects no longer moving in conjunction with each other, and a plurality of objects no longer moving in conjunction with each other including an object that keeps moving and an object that is stationary. Further, the detection results include a distance (hereinafter referred to as a "detection distance") from the image forming device 2 to the location at which an object is detected.

The management unit 112 manages various kinds of information. For example, the management unit 112 stores the detection results from the human sensor 100 acquired by the acquisition unit 111 in the storage unit 20 and manages such information. Specifically, when it is determined that the person 501 has entered the person detection region 201, the management unit 112 stores the state of the left property region 202 at that time in the storage unit 20 and manages such information. When it is determined that the person 501 has left the person detection region 201, the management unit 112 stores the state of the left property region 202 at that time in the storage unit 20 and manages such information. When it is determined that the person 501 has left the left property region 202, the management unit 112 is able to store the state of the left property region 202 at that time in the storage unit 20 and manage such information.

The object determination unit 113 is able to perform the object determination process on the basis of the detection results from the human sensor 100. For example, as the object determination process, the object determination unit 113 determines an object that is moving alone as a person 501 and determines an object that is stationary when alone as an article 601, among the objects detected as being present in each of the divided regions of the detectable region 200.

The object determination unit 113 performs the object determination process when it is detected that the plurality of objects that have been moving in conjunction with each other in the detectable region 200 are no longer moving in conjunction with each other and, further, the plurality of objects that are no longer moving in conjunction with each other include an object that keeps moving and an object that is stationary. That is, the object determination unit 113 determines the object that keeps moving as the person 501 and determines the object that is stationary as the article 601, among the plurality of objects that are no longer moving in conjunction with each other.

The object determination unit 113 determines whether or not the person 501 has entered the detectable region 200 and whether or not the person 501 has left the detectable region 200 on the basis of the detection distance acquired as the detection results. The determination by the object determination unit 113 as to whether or not the person 501 has entered the detectable region 200 includes a determination as to whether or not the person 501 has entered the person detection region 201 and a determination as to whether or not the person 501 has entered the left property region 202. The determination by the object determination unit 113 as to whether or not the person 501 has left the detectable region 200 includes the following determinations. That is, the determination includes a determination as to whether or not the person 501 has left the detectable region 200 from the person detection region 201, and a determination as to whether or not the person 501 has left the detectable region 200 from the left property region 202.

The determination as to whether or not the person 501 has entered the person detection region 201 includes not only a determination as to whether or not the person 501 has entered the person detection region 201 from the outside of the detectable region 200, but also a determination as to whether or not the person 501 has moved from the left property region 202 to the person detection region 201. The determination as to whether or not the person 501 has entered the left property region 202 includes not only a determination as to whether or not the person 501 has entered the left property region 202 from the outside of the detectable region 200, but also a determination as to whether or not the person 501 has moved from the person detection region 201 to the left property region 202.

The determination as to whether or not the person 501 has left the person detection region 201 includes not only a determination as to whether or not the person 501 has left the detectable region 200 from the person detection region 201, but also a determination as to whether or not the person 501 has moved from the person detection region 201 to the left property region 202. The determination as to whether or not the person 501 has left the left property region 202 includes not only a determination as to whether or not the person 501 has left the detectable region 200 from the left property region 202, but also a determination as to whether or not the person 501 has moved from the left property region 202 to the person detection region 201.

The left property determination unit 114 is able to perform the left property determination process on the basis of the results of the object determination process by the object determination unit 113. Specifically, as the left property determination process, the left property determination unit 114 is able to determine whether or not there is any left property when the person 501 having entered the detectable region 200 has left the detectable region 200. Whether or not there is any left property may be determined in accordance with whether or not the object having been determined as the person 501 has left the detectable region 200 and the object having been determined as the article 601 remains in the detectable region 200, as illustrated in FIG. 3, for example. Alternatively, it may be determined in accordance with whether or not the object having been determined as the person 501 has left the person detection region 201 and the object having been determined as the article 601 remains in the left property region 202, as illustrated in FIGS. 4 and 5, for example. Further, it may be determined in accordance with whether or not the object having been determined as the person 501 has left the left property region 202 and the object having been determined as the article 601 remains in the left property region 202.

The notification control unit 115 performs control for the left property notification process. Specifically, if a mail address of the person 501 has been registered in advance, as the left property notification process, the notification control unit 115 is able to perform control so as to notify an information processing device such as a smartphone (not illustrated) possessed by the person 501 that there is a left property. When the person 501 has left the detectable region 200 or when the person 501 has left the left property region 202, as the left property notification process, the notification control unit 115 is able to perform control so as to output a sound indicating that there is a left property.

The notification control unit 115 is able not to perform the left property notification process when the non-notification condition is met, even if it is determined that the article 601 is present in the detectable region 200 and the person 501 has ceased to be present in the detectable region 200. The notification control unit 115 is able not to perform the left property notification process when the non-notification condition is met, even if it is determined that the article 601 is present in the left property region 202 and the person 501 has ceased to be present in the person detection region 201 or the left property region 202.

### Flow of Object Determination Process, Left Property Determination Process, and Left Property Notification Process

Next, the flow of the object determination process, the left property determination process, and the left property notification process discussed above will be described with reference to FIGS. 1 to 8.

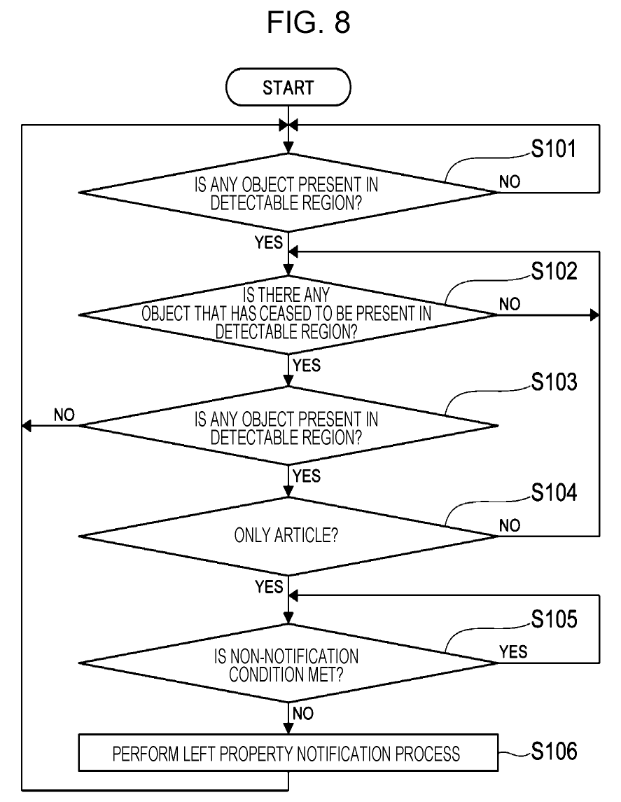

FIG. 8 is a flowchart illustrating an example of the flow of the object determination process, the left property determination process, and the left property notification process by the image forming device 2 in FIG. 7 for a case where the left property region 202 is not formed in the detectable region 200. It should be noted that FIG. 8 indicates the flow of a process from an initial state in which no object is present in the detectable region 200.

When an object is present in the detectable region 200 (YES in step 101), the image forming device 2 determines that a person has entered the detectable region 200, and proceeds to a determination process in step 102. When an object is not present in the detectable region 200 (NO in step 101), on the other hand, the image forming device 2 determines that a person has not entered the detectable region 200, and repeatedly performs the determination process in step 101.

When there is an object that has ceased to be present in the detectable region 200 (YES in step 102), the image forming device 2 determines that a person has left the detectable region 200, and proceeds to a determination process in step 103. When there is not an object that has ceased to be present in the detectable region 200 (NO in step 102), on the other hand, the image forming device 2 determines that a person has not left the detectable region 200, and repeatedly performs the determination process in step 102.

When an object is present in the detectable region 200 (YES in step 103), the image forming device 2 determines that there is possibly a left property in the detectable region 200, and proceeds to a determination process in step 104. When an object is not present in the detectable region 200 (NO in step 103), on the other hand, the image forming device 2 determines that there is not a left property in the detectable region 200, and returns to the determination process in step 101.

When it is determined that the object that is present in the detectable region 200 includes only an article 601 (YES in step 104), the image forming device 2 determines that there is possibly a left property in the detectable region 200 and proceeds to a determination process in step 105. When it is determined that the object that is present in the detectable region 200 does not only include an article 601 (i.e. but also includes a person 501) (NO in step 104), on the other hand, the image forming device 2 determines that there is not a left property in the detectable region 200 and returns to the process in step 102.

When the non-notification condition is met (YES in step 105), the image forming device 2 determines that there is not a left property in the detectable region 200 and repeatedly performs the determination process in step 105. When the non-notification condition is no longer met (NO in step 105), on the other hand, the image forming device 2 determines that there is a left property in the detectable region 200, performs the left property notification process (step 106), and returns to the process in step 101.

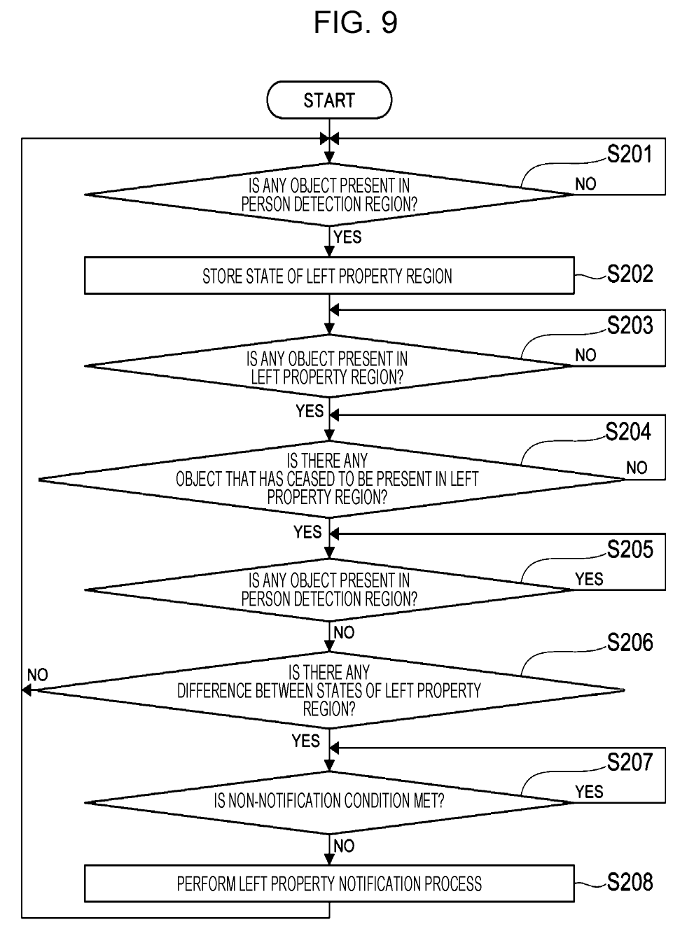

FIG. 9 is a flowchart illustrating an example of the flow of the object determination process, the left property determination process, and the left property notification process by the image forming device 2 in FIG. 7 for a case where the left property region 202 is formed in the detectable region 200. It should be noted that FIG. 9 indicates the flow of a process from an initial state in which no object is present in the detectable region 200.

When an object is present in the person detection region 201 (YES in step 201), the image forming device 2 determines that a person has entered the person detection region 201, and proceeds to the process in step 202. When an object is not present in the person detection region 201 (NO in step 201), on the other hand, the image forming device 2 determines that a person has not entered the person detection region 201, and repeatedly performs the determination process in step 201.

The image forming device 2 stores the state of the left property region 202 (step 202). When an object is present in the left property region 202 (YES in step 203), the image forming device 2 determines that a person has entered the left property region 202, and proceeds to a determination process in step 204. When an object is not present in the left property region 202 (NO in step 203), on the other hand, the image forming device 2 determines that a person has not entered the left property region 202, and repeatedly performs the determination process in step 203.

When there is an object that has ceased to be present in the left property region 202 (YES in step 204), the image forming device 2 determines that a person has left the left property region 202, and proceeds to a determination process in step 205. When there is not an object that has ceased to be present in the left property region 202 (NO in step 204), on the other hand, the image forming device 2 determines that a person has not entered the left property region 202, and repeatedly performs the determination process in step 204.

When an object is present in the person detection region 201 (YES in step 205), the image forming device 2 determines that a person remains in the person detection region 201, and repeatedly performs the process in step 205. When an object is not present in the person detection region 201 (NO in step 205), on the other hand, the image forming device 2 determines that a person has left the person detection region 201, and proceeds to a determination process in step 206.

The image forming device 2 makes a comparison between the state of the left property region 202 at that time and the state of the left property region 202 stored in step 202. Then, when there is a difference between the states of the left property region 202 (YES in step 206), the image forming device 2 determines that there is possibly a left property in the left property region 202, and proceeds to a determination process in step 207. When there is not a difference between the states of the left property region 202 (NO in step 206), on the other hand, the image forming device 2 determines that there is not a left property in the left property region 202, and returns to the determination process in step 201.

When the predetermined non-notification condition is met (YES in step 207), the image forming device 2 repeatedly performs the determination process in step 207. When the non-notification condition is no longer met (NO in step 207), the image forming device 2 determines that there is a left property in the left property region 202, performs the left property notification process (step 208), and returns to the determination process in step 201.

### Other Specific Examples

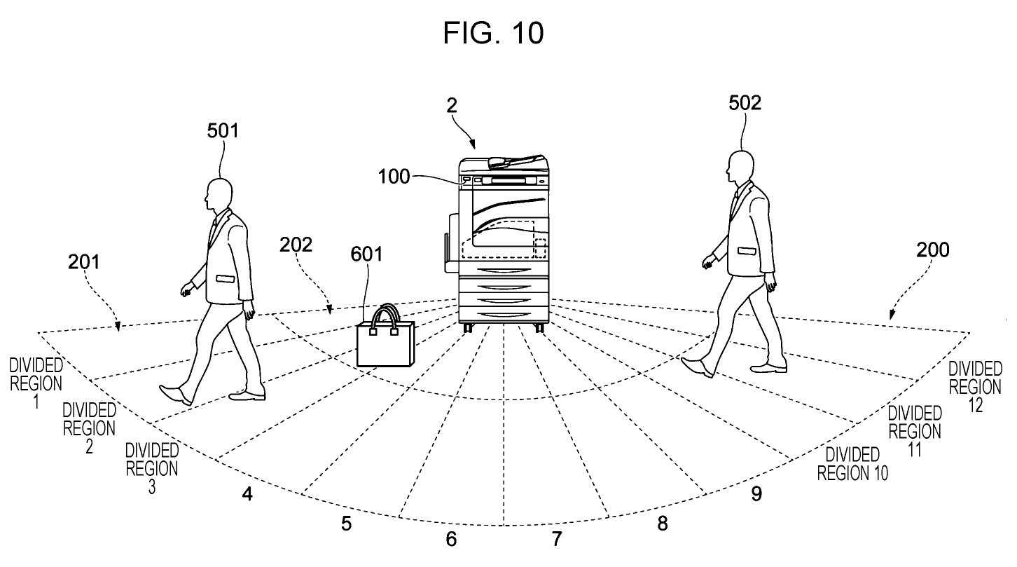

FIG. 10 illustrates a specific example of a case where a different person 502 is present in the person detection region 201 when a person 501 has left the person detection region 201.

As indicated in the flowchart in FIG. 9 discussed above, when an object is not present in the person detection region 201, the image forming device 2 determines that a person has left the person detection region 201 (see step 205). Then, the image forming device 2 determines whether or not there is a difference between the states of the left property region 202 (see step 206).

When the image forming device 2 is installed at a location with heavy human traffic such as a convenience store, a different person is occasionally present in the person detection region 201. In this case, it is difficult for the image forming device 2 to determine that a person has left the person detection region 201. For example, there may be a case where a different person 502 is present in the person detection region 201 when a person 501 having left the person detection region 201 has left an article 601 in the left property region 202, as illustrated in FIG. 10. Examples of the case where a different person 502 is present in the person detection region 201 when a person 501 has left the person detection region 201 include a case where the different person 502 is waiting to use the image forming device 2 after the person 501. In this case, it is difficult for the image forming device 2 to determine that the person 501 has left the person detection region 201.

The image forming device 2 is able to make a comparison between the states of the left property region 202 when the person 501 has left the left property region 202, not the person detection region 201, as discussed above. That is, when the person 501 is present in the left property region 202 and the different person 502 is present in a region other than the left property region 202, the image forming device 2 stores the presence or absence of an article 601 in the left property region 202 at the time when the person 501 has left the left property region 202. Then, the image forming device 2 makes a comparison between the states of the left property region 202 when the person 501 has left the left property region 202 and determines the presence or absence of a left property on the basis of the difference between the states of the left property region 202. This makes it possible to determine the presence or absence of a left property of the person 501 even when the different person 502 is present in the person detection region 201.

### Other Exemplary Embodiments

While the present exemplary embodiment has been described above, the present disclosure is not limited to the exemplary embodiment discussed above. The effect of the present disclosure is also not limited to that described in relation to the exemplary embodiment discussed above. For example, the overall configuration of the image forming system 1 illustrated in FIG. 1, the hardware configuration of the image forming device 2 illustrated in FIG. 2, and the functional configuration of the image forming device 2 illustrated in FIG. 7 are merely exemplary for achieving the object of the present disclosure, and are not specifically limiting. That is, it is only necessary that the image forming system 1 in FIG. 1 should include the function of executing the processes discussed above as a whole, and the example discussed above does not limit the hardware configuration and the functional configuration for implementing the function.

The order of process steps by the image forming device 2 indicated in the flowcharts in FIG. 8 and 9 is also merely exemplary, and is not specifically limiting. The illustrated processes are not necessarily performed chronologically along the step order, and may be performed concurrently or individually. The specific examples illustrated in FIGS. 3 to 6 and 10 are also merely exemplary, and are not specifically limiting.

For example, while the image forming device 2 includes a built-in human sensor 100 in the exemplary embodiment discussed above, the human sensor 100 may be installed separately from the image forming device 2. For example, the human sensor 100 may be installed around the device, on the ceiling of the room, or the like. A signal from the human sensor 100 may be output in the range of 360°. In this case, the image forming device 2 stores the state of the left property region 202 which is a circular region with a smaller area than the person detection region 201 in an annular shape, which makes it possible to determine the presence or absence of a left property irrespective of the direction in which a person enters and thereafter leaves the detectable region 200.

While one or two persons enter the detectable region 200 in the exemplary embodiment discussed above, this is not limiting. The object determination process, the left property determination process, and the left property notification process discussed above may be performed also when three or more persons enter the detectable region 200.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An image forming system comprising:

a control unit that performs different control when a second target that has been moving in conjunction with motion of a first target within a predetermined region is no longer moving in conjunction with the first target and has become stationary, the different control being different from control performed otherwise.

(((2)))

The image forming system according to (((1))),

wherein the different control includes making a notification of a left property.

(((3)))

The image forming system according to (((2))),

wherein the control unit makes the notification when the second target is present in the predetermined region and the first target has ceased to be present in the predetermined region.

(((4)))

The image forming system according to (((3))),

wherein the control unit does not make the notification under a predetermined condition even when the second target is present in the predetermined region and the first target has ceased to be present in the predetermined region.

(((5)))

The image forming system according to (((4))),

wherein the predetermined condition is a condition that determines an event in which the first target returns to the predetermined region.

(((6)))

The image forming system according to any one of (((1))) to (((5))),

wherein the control unit makes a comparison between presence or absence of the second target in the predetermined region at a time when the first target has entered the predetermined region and presence or absence of the second target in the predetermined region at a time when the first target has left the predetermined region, and performs different control when a result of the comparison is different, the different control being different from control performed otherwise.

(((7)))

The image forming system according to (((6))),

wherein the control unit stores presence of the second target in a left property region that is a region with a smaller area than the predetermined region.

(((8)))

The image forming system according to (((7))), further comprising:

a device that is operated by the first target,

wherein the predetermined region and the left property region extend in a sector shape around the device.

(((9)))

The image forming system according to (((7))) or (((8))),

wherein when one first target is present in the left property region and another first target is present in a region other than the left property region, of the predetermined region, the control unit stores presence or absence of the second target in the left property region at a time when the one first target has left the left property region.

What is claimed is:

1. An image forming system comprising:
a control unit that performs different control when a second target that has been moving in conjunction with motion of a first target within a predetermined region is no longer moving in conjunction with the first target and has become stationary, the different control being different from control performed otherwise.

2. The image forming system according to claim 1,
wherein the different control includes making a notification of a left property.

3. The image forming system according to claim 2,
wherein the control unit makes the notification when the second target is present in the predetermined region and the first target has ceased to be present in the predetermined region.

4. The image forming system according to claim 3,
wherein the control unit does not make the notification under a predetermined condition even when the second target is present in the predetermined region and the first target has ceased to be present in the predetermined region.

5. The image forming system according to claim 4,
wherein the predetermined condition is a condition that determines an event in which the first target returns to the predetermined region.

6. The image forming system according to claim 1,
wherein the control unit makes a comparison between presence or absence of the second target in the predetermined region at a time when the first target has entered the predetermined region and presence or absence of the second target in the predetermined region at a time when the first target has left the predetermined region, and performs different control when a result of the comparison is different, the different control being different from control performed otherwise.

7. The image forming system according to claim 6,
wherein the control unit stores presence of the second target in a left property region that is a region with a smaller area than the predetermined region.

8. The image forming system according to claim 7, further comprising:
a device that is operated by the first target,
wherein the predetermined region and the left property region extend in a sector shape around the device.

9. The image forming system according to claim 7,
wherein when one first target is present in the left property region and another first target is present in a region other than the left property region, of the predetermined region, the control unit stores presence or absence of the second target in the left property region at a time when the one first target has left the left property region.

10. An image forming system comprising:
means for performing different control when a second target that has been moving in conjunction with motion of a first target within a predetermined region is no longer moving in conjunction with the first target and has become stationary, the different control being different from control performed otherwise.
